(19) United States
(12) Patent Application Publication
(10) Pub. No.: US 2012/0099333 A1
(43) Pub. Date: Apr. 26, 2012

(54) Flashlight Mount

(76) Inventor: Ching-Hsiang Wang, Tainan City (TW)

(21) Appl. No.: 12/910,915

(22) Filed: Oct. 25, 2010

(51) Int. Cl. F21V 21/08

(52) U.S. Cl. 362/396

(57) ABSTRACT

A flashlight mount includes a clamp-type positioning element, an annular clamping element pivotally connected to an upper section of the clamp-type positioning element, a screw nut for limiting the position of the annular clamping element, and upper and lower screw rods screwed in one end of the annular clamping element and one end of the clamp-type positioning element respectively. To fasten a flashlight to the mount, the flashlight is inserted at one end into an enclosing tube of the annular clamping element, and the upper screw rod is rotated downward to fix the flashlight in position. Then, an object to be clamped is inserted into an insertion space on a lateral side of the clamp-type positioning element, and the lower screw rod is rotated upward to fasten the clamp-type positioning element to the object. The mount enables flexible installation and angular adjustment of the flashlight to meet lighting requirements.

### BACKGROUND OF THE INVENTION

1. Technical Field

The present invention relates to flashlight mounts and, more particularly, to a flashlight mount for fixing a flashlight securely in position and for being firmly clamped to the edge of a hat designed to provide lighting, so as to increase the flexibility of flashlight installation.

2. Description of Related Art

Nowadays, flashlights for illumination purposes can be conveniently adapted to various lighting situations by fastening the flashlights to clamping devices having the appropriate configurations. These clamping devices can be secured to objects intended for different uses to facilitate the installation and removal of flashlights when it is desired to use or not to use the flashlights. Furthermore, in order to enable flexible adjustment of the lighting angle of a flashlight fastened to such a clamping device, a certain section of the clamping device is typically provided with a component configured for angular adjustment, thus allowing users to adjust the lighting direction as needed.

### BRIEF SUMMARY OF THE INVENTION

The present invention provides a flashlight mount of a novel configuration as an improvement over the conventional flashlight mounts that are designed to be clamped to the edges of various objects. The disclosed flashlight mount can fix a flashlight securely in position and be firmly clamped to the edge of a hat that is intended to provide lighting. With the present invention, the flexibility of flashlight installation is increased.

The first major object of the present invention is to provide a mount for clamping a flashlight, wherein the mount includes a clamp-type positioning element, a lower screw rod, an annular clamping element, a screw nut, and an upper screw rod. The clamp-type positioning element has a lower section formed with an insertion space that extends laterally inward. The clamp-type positioning element further has a lower end which is adjacent to the insertion space and penetrated by a threaded hole in which the lower screw rod is screwed. The clamp-type positioning element also has an upper section formed as a receiving tube that has an inwardly extending ball-shaped space. The receiving tube has a threaded outer periphery and is circumferentially formed with a plurality of slots. The slots allow a ball-shaped connecting portion extending from a lower section of the annular clamping element to be inserted into the receiving tube. The screw nut is mounted around the ball-shaped connecting portion and screwed on the outer periphery of the receiving tube such that the annular clamping element is pivotally connected to the clamp-type positioning element. The annular clamping element has an upper section formed as an enclosing tube that extends vertically and has an elliptical cross-section. The upper end of the enclosing tube is extended with a tube having a threaded hole in which the upper screw rod is screwed. To fasten a flashlight to the mount, the flashlight is inserted at one end into the enclosing tube of the annular clamping element, and then the upper screw rod is rotated downward to fix the flashlight in position. Following that, an object to be clamped is inserted into the insertion space extending laterally into the lower section of the clamp-type positioning element, and the lower screw rod is rotated upward to secure the clamp-type positioning element to the object in a clamping manner. Thus, not only can the flashlight be flexibly installed, but also the lighting angle of the flashlight can be adjusted as appropriate.

The second major object of the present invention to provide a mount for clamping a flashlight, wherein the mount includes an insertion-type positioning element, an annular clamping element, a screw nut, and an upper screw rod. The insertion-type positioning element has a lower section extended with an insertion part. The insertion part has a surface formed with at least one resilient pressing portion. The insertion-type positioning element also has an upper section formed as a receiving tube that has an inwardly extending ball-shaped space. The receiving tube has a threaded outer periphery and is circumferentially formed with a plurality of slots. The slots allow a ball-shaped connecting portion extending from a lower section of the annular clamping element to be inserted into the receiving tube. The screw nut is mounted around the ball-shaped connecting portion and screwed on the outer periphery of the receiving tube such that the annular clamping element is pivotally connected to the insertion-type positioning element. The annular clamping element has an upper section formed as an enclosing tube that extends vertically and has an elliptical cross-section. The upper end of the enclosing tube is extended with a tube having a threaded hole in which the upper screw rod is screwed. To fasten a flashlight to the mount, the flashlight is inserted into the enclosing tube of the annular clamping element, and the upper screw rod is rotated downward to fix the flashlight in position. Following that, the insertion part extending downward from the insertion-type positioning element is inserted into a predetermined space of an object to be connected with the mount. As a result, the at least one resilient pressing portion on one surface of the insertion part presses tightly against the wall of the predetermined space to secure the insertion-type positioning element to the object. Thus, not only is flexible installation of the flashlight achievable, but also the lighting angle of the flashlight can be adjusted as desired.

The third object of the present invention to provide the foregoing mounts for clamping a flashlight, wherein the enclosing tube in the upper section of the annular clamping element is laterally provided with a space that extends outward. This outwardly extending space allows the enclosing tube to press resiliently against the flashlight fastened to the mount regardless of the cross-sectional shape of the flashlight. If the flashlight is laterally provided with an engaging section, the engaging section can be inserted and received in this outwardly extending space.

The fourth object of the present invention to provide the foregoing mount that includes the insertion-type positioning element, wherein the insertion part of the insertion-type positioning element has a lower end laterally extended with a hook. After the insertion part is inserted into the predetermined space of the object to be connected with the mount, the hook is engaged with a bottom portion of the object to fix the mount in position to the object.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is an exploded perspective view of a flashlight mount according to a first embodiment of the present invention;

FIG. 2 is an assembled perspective view of the flashlight mount depicted in FIG. 1;

FIG. 3 is a front sectional view of the flashlight mount depicted in FIG. 1;

FIG. 4 is a perspective view showing the flashlight mount depicted in FIG. 1 and a flashlight having a circular cross-section that is to be fastened to the flashlight mount;

FIG. 5 is a front sectional view showing the flashlight mount depicted in FIG. 1 and the flashlight depicted in FIG. 4 in the assembled state;

FIG. 6 is a perspective view showing the flashlight mount depicted in FIG. 1 and a flashlight having an elliptical cross-section that is to be fastened to the flashlight mount;

FIG. 7 is a front sectional view showing the flashlight mount depicted in FIG. 1 and the flashlight depicted in FIG. 6 in the assembled state;

FIG. 8 is an exploded perspective view of a flashlight mount according to a second embodiment of the present invention;

FIG. 9 is an assembled perspective view of the flashlight mount depicted in FIG. 8;

FIG. 10 is a front sectional view of the flashlight mount depicted in FIG. 8;

FIG. 11 a perspective view showing the flashlight mount depicted in FIG. 8 and a flashlight having a circular cross-section that is to be fastened to the flashlight mount;

FIG. 12 is a front sectional view showing the flashlight mount depicted in FIG. 8 and the flashlight depicted in FIG. 11 in the assembled state;

FIG. 13 is a perspective view showing the flashlight mount depicted in FIG. 8 and a flashlight having an elliptical cross-section that is to be fastened to the flashlight mount; and

FIG. 14 is a front sectional view showing the flashlight mount depicted in FIG. 8 and the flashlight depicted in FIG. 13 in the assembled state.

### DETAILED DESCRIPTION OF THE INVENTION

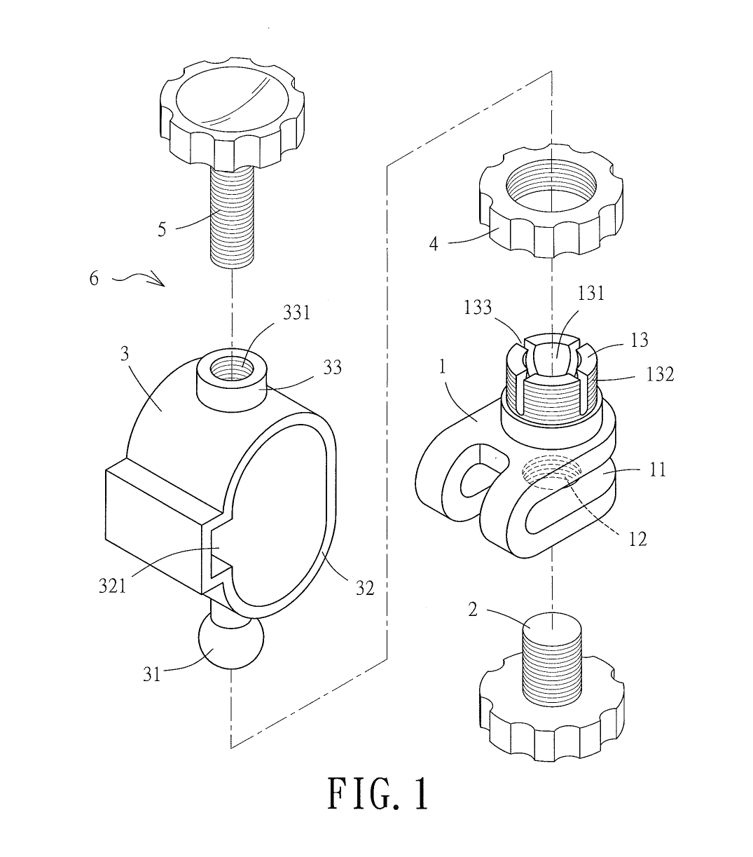

Referring to FIG. 1, a flashlight mount 6 according to a first embodiment of the present invention is configured to clamp a flashlight and includes a clamp-type positioning element 1, a lower screw rod 2, an annular clamping element 3, a screw nut 4, and an upper screw rod 5.

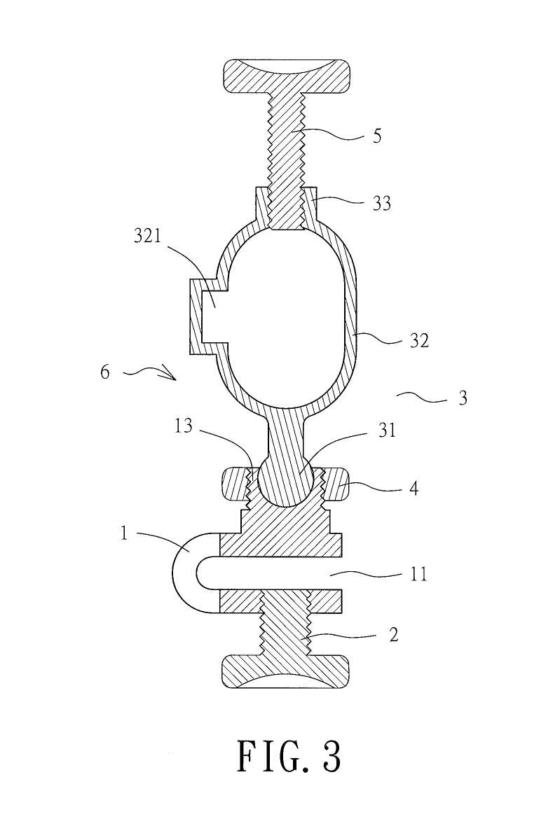

The clamp-type positioning element 1 has a lower section formed with an insertion space 11. More specifically, the insertion space 11 extends laterally into the lower section of the clamp-type positioning element 1. The clamp-type positioning element 1 further has a lower end which is adjacent to the insertion space 11 and penetrated by a threaded hole 12 into which the lower screw rod 2 can be screwed. The upper section of the clamp-type positioning element 1 is formed as a receiving tube 13 having an inwardly extending ball-shaped space 131, as can be seen more clearly in FIG. 3. The outer periphery of the receiving tube 13 is formed with threads 132, and the receiving tube 13 is circumferentially provided with a plurality of slot 133 to facilitate tightening of the screw nut 4.

The annular clamping element 3 has a lower section extended with a ball-shaped connecting portion 31 and an upper section formed as an enclosing tube 32, wherein the enclosing tube 32 extends vertically and has an elliptical cross-section. In addition, the enclosing tube 32 is laterally provided with an outwardly extending space 321. (The space 321 allows the enclosing tube 32 to press resiliently against the flashlight fastened to the mount 6 regardless of the cross-sectional shape of the flashlight.) The upper end of the enclosing tube 32 is extended with a tube 33 having a threaded hole 331 into which the upper screw rod 5 can be screwed.

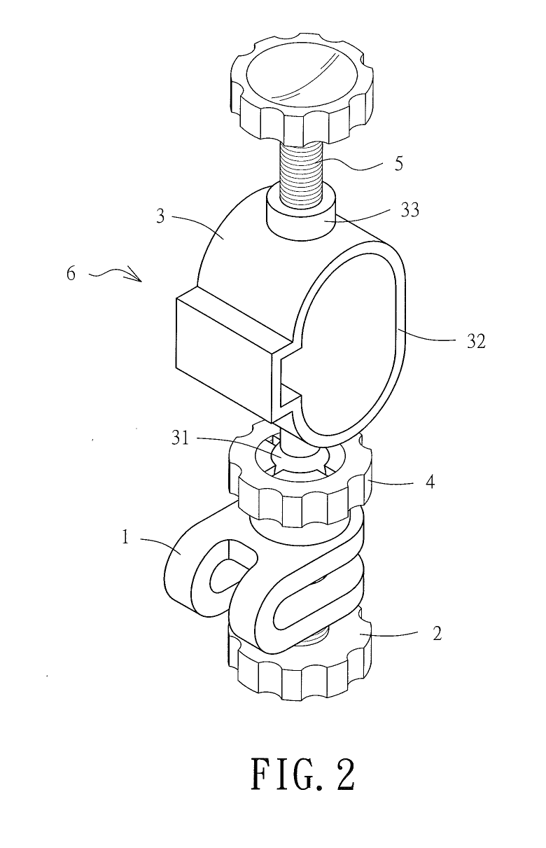

The clamp-type positioning element 1 and the annular clamping element 3 are put together in the following manner. Referring to FIG. 2 and FIG. 3, the lower screw rod 2 is screwed into the threaded hole 12 at the lower end of the clamp-type positioning element 1. The screw nut 4 is mounted in advance around the ball-shaped connecting portion 31 in the lower section of the annular clamping element 3. Then, the ball-shaped connecting portion 31 of the annular clamping element 3 is inserted into the ball-shaped space 131 formed in the upper section of the clamp-type positioning element 1. Following that, the screw nut 4, which has been mounted around the ball-shaped connecting portion 31, is screwed on the outer periphery of the receiving tube 13 to form a pivotal connection between the annular clamping element 3 and the clamp-type positioning element 1. The assembly process of the mount 6 is completed after the upper screw rod 5 is screwed into the tube 33 at the upper end of the enclosing tube 32 of the annular clamping element 3.

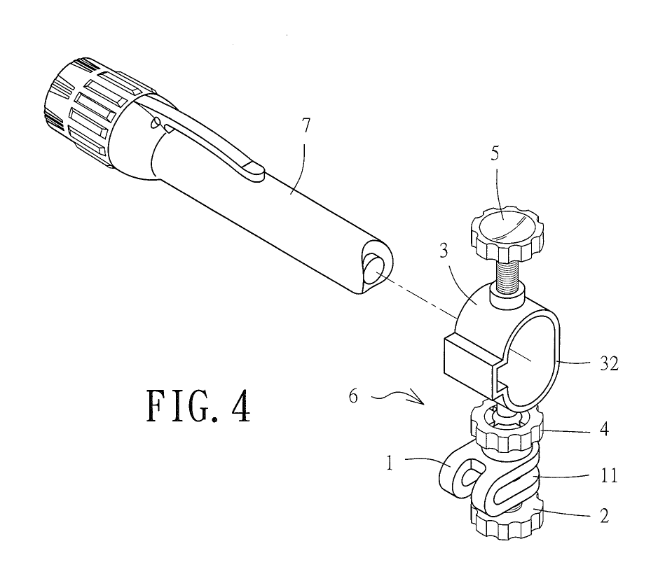

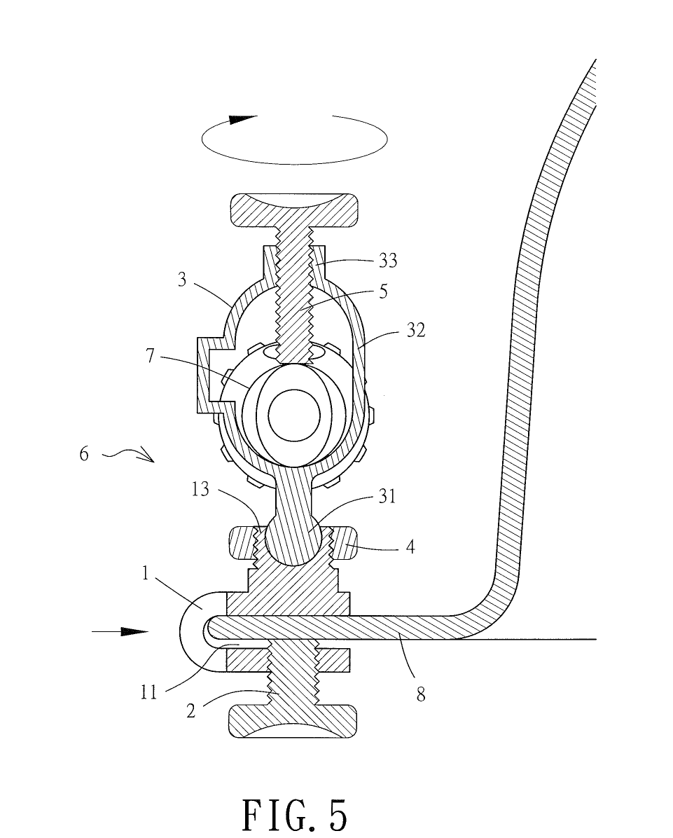

Referring to FIG. 4 and FIG. 5, a flashlight 7 having a circular cross-section and no engaging section is fastened to the mount 6 as follows. To begin with, the flashlight 7 is inserted at one end into the enclosing tube 32 of the annular clamping element 3. Then, the upper screw rod 5 is rotated downward to fix the flashlight 7 in position. Afterward, an object to which the mount 6 is to be clamped (exemplified herein by the edge 8 of a fireman's helmet) is inserted into the insertion space 11 extending laterally into the lower section of the clamp-type positioning element 1. Finally, the lower screw rod 2 is rotated upward to fasten the clamp-type positioning element 1 to the object in a clamping fashion. Thus, the flashlight 7 not only can be flexibly installed but also allows angular adjustment to the desired lighting directions.

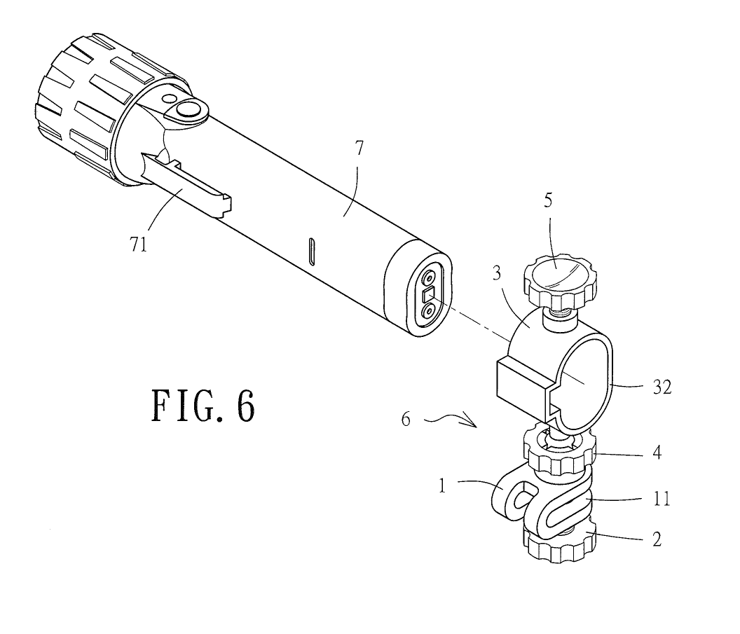

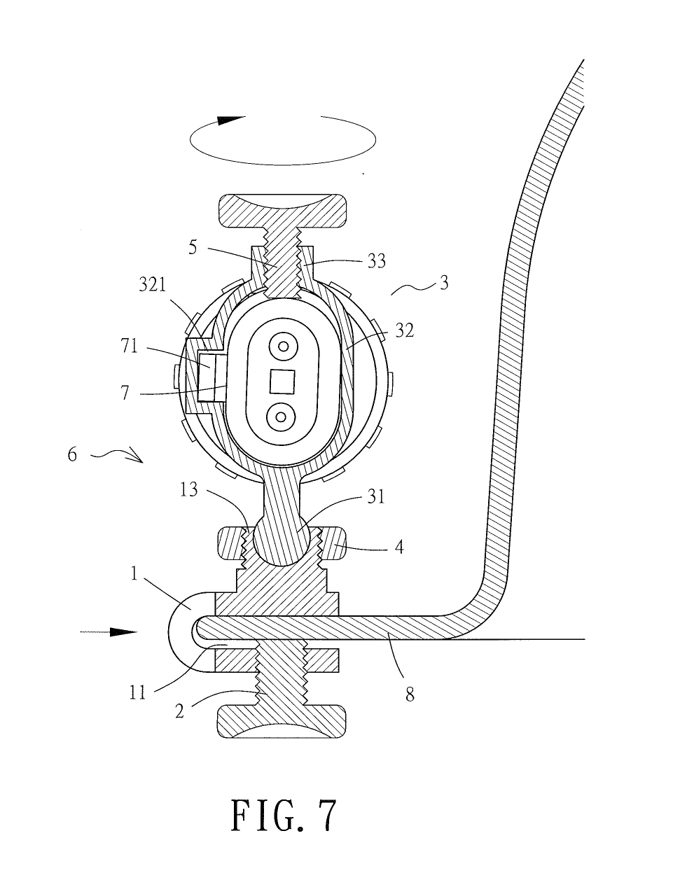

Referring to FIG. 6 and FIG. 7, a flashlight 7 having an elliptical cross-section and an engaging section 71 is fastened to the mount 6 in the same way as described in the previous paragraph, except that the engaging section 71 provided on a lateral side of the flashlight 7 must be inserted and received in the space 321 laterally provided in the annular clamping element 3 so that the flashlight 7 is properly retained by the annular clamping element 3.

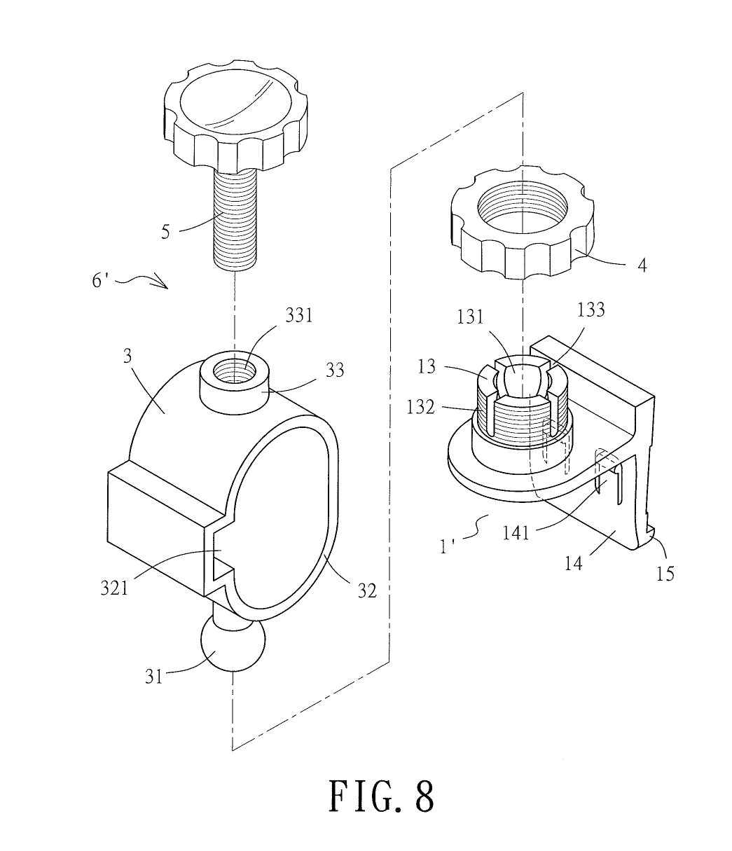

FIG. 8 shows a flashlight mount 6′ according to a second embodiment of the present invention, wherein the flashlight mount 6′ includes an insertion-type positioning element 1′, an annular clamping element 3, a screw nut 4, and an upper screw rod 5. The annular clamping element 3, the screw nut 4, and the upper screw rod 5 in the present embodiment have the same configurations as their counterparts in the first embodiment. The second embodiment is different from the first embodiment in the insertion-type positioning element 1′.

The insertion-type positioning element 1′ has a lower section extended with an insertion part 14. The insertion part 14 has a surface formed with at least one resilient pressing portion 141. In addition, the lower end of the insertion part 14 is laterally extended with a hook 15. The insertion-type positioning element 1′ further has an upper section formed as a receiving tube 13 having an inwardly extending ball-shaped space 131. The receiving tube 13 has an outer periphery formed with threads 132 and is circumferentially provided with a plurality of slots 133.

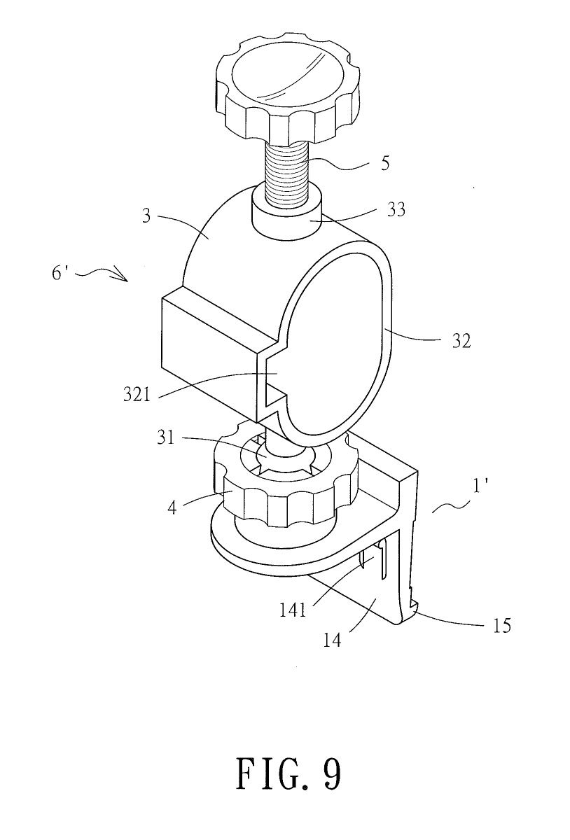

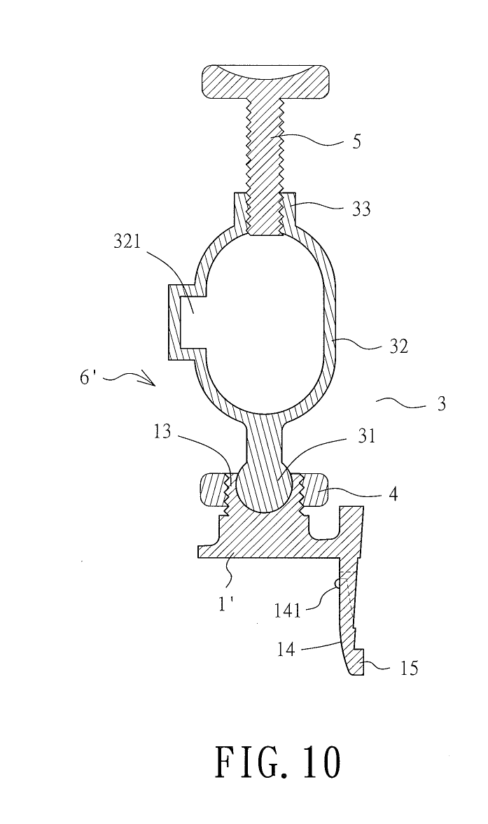

The insertion-type positioning element 1′ and the annular clamping element 3 are assembled in the following way. As shown in FIG. 9 and FIG. 10, a ball-shaped connecting portion 31 extending from the lower section of the annular clamping element 3 is inserted into the ball-shaped space 131 formed in the upper section of the insertion-type positioning element F. Then, the screw nut 4, which has been mounted around the ball-shaped connecting portion 31 in advance, is screwed on the outer periphery of the receiving tube 13 such that the annular clamping element 3 is pivotally connected to the insertion-type positioning element V. Finally, the upper screw rod 5 is screwed into the tube 33 at the upper end of the enclosing tube 32 of the annular clamping element 3 to conclude the assembly process of the mount 6′.

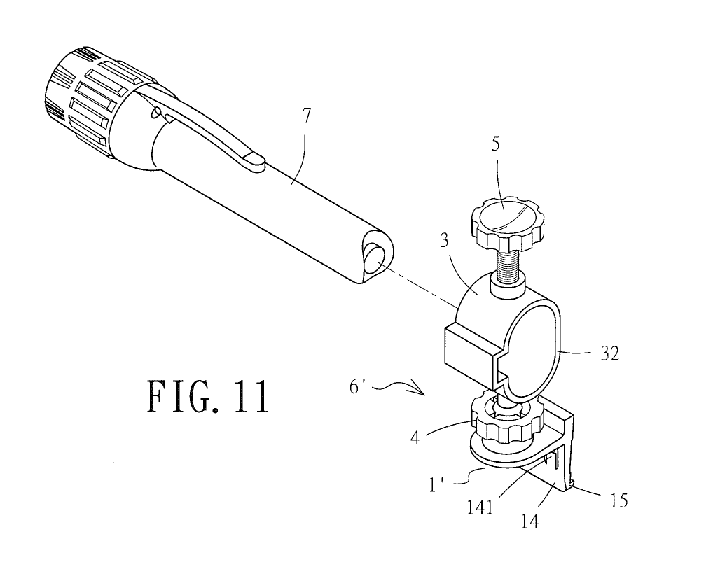

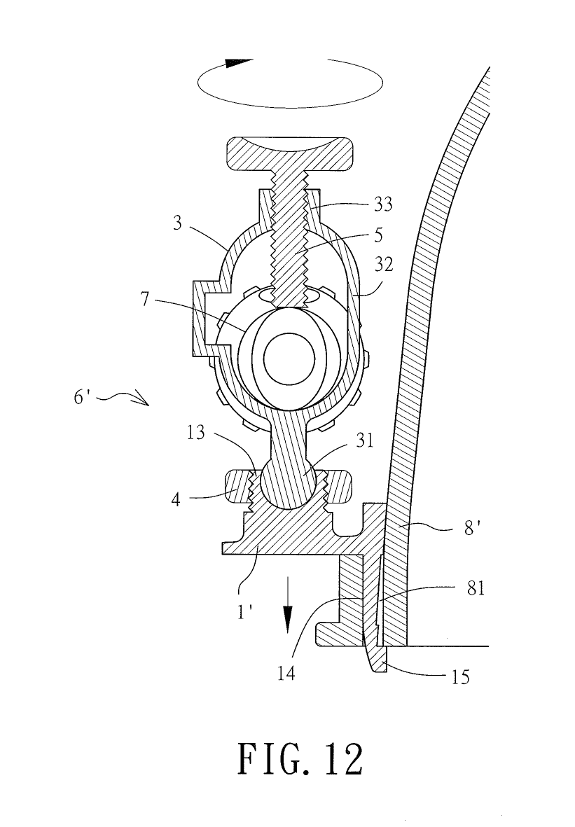

Referring to FIG. 11 and FIG. 12, in order to fasten a flashlight 7 having a circular cross-section and no engaging section to the mount 6′, the flashlight 7 is inserted at one end into the enclosing tube 32 of the annular clamping element 3. Next, the upper screw rod 5 is rotated downward to fix the flashlight 7 in place. Following that, the downwardly extending insertion part 14 of the insertion-type positioning element 1′ is inserted into a predetermined space 81 of an object to which the mount 6′ is to be connected (exemplified herein by the edge 8′ of a fireman's helmet whose form is different from that shown in the previous embodiment). As a result, the resilient pressing portions 141 on one surface of the insertion part 14 press against the wall of the predetermined space 81, and the hook 15 is engaged with a bottom portion of the object, thereby connecting the insertion-type positioning element 1′ firmly to the object. Hence, the flashlight 7 not only can be flexibly installed but also can be angularly adjusted to the desired lighting directions.

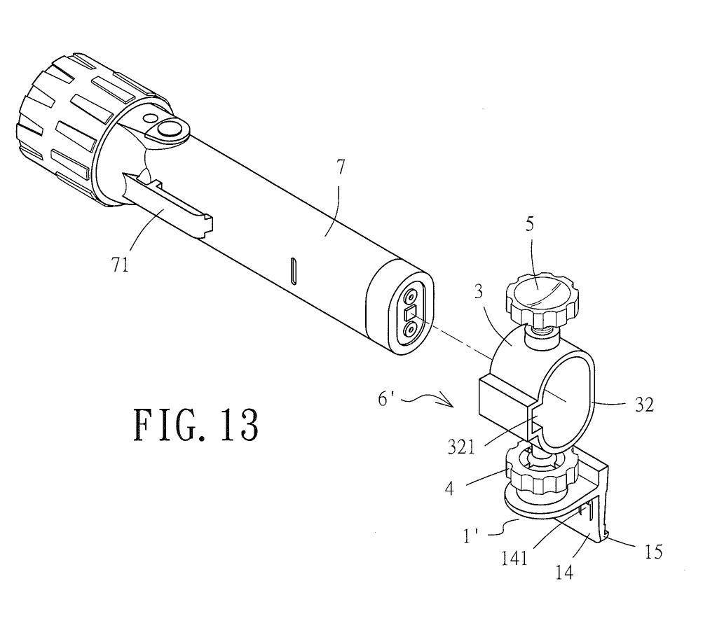

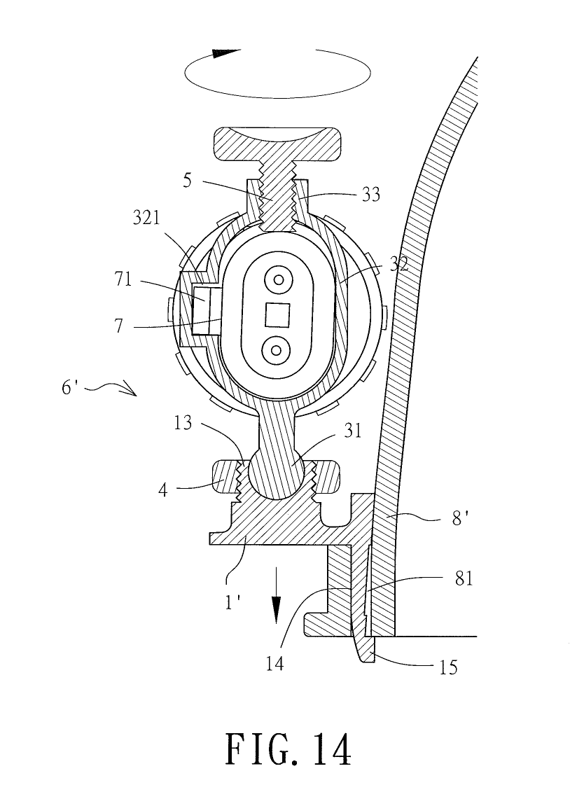

Referring to FIG. 13 and FIG. 14, if the flashlight 7 has an elliptical cross-section and an engaging section 71, it is fastened to the mount 6′ in the same way as described above, except that the engaging section 71 provided on a lateral side of the flashlight 7 must be inserted and received in the space 321 laterally provided in the annular clamping element 3, thus allowing the flashlight 7 to be properly restricted by the annular clamping element 3.

What is claimed is:

1. A flashlight mount, comprising a clamp-type positioning element, a lower screw rod, an annular clamping element, a screw nut, and an upper screw rod, the clamp-type positioning element having a lower section formed with an insertion space, the insertion space extending laterally into the lower section of the clamp-type positioning element, the clamp-type positioning element having a lower end which is adjacent to the insertion space and penetrated by a threaded hole in which the lower screw rod is screwed, the clamp-type positioning element having an upper section formed as a receiving tube, the receiving tube having an inwardly extending ball-shaped space and an outer periphery provided with threads, the receiving tube being circumferentially provided with a plurality of slots for allowing a ball-shaped connecting portion extending from a lower section of the annular clamping element to be inserted into the receiving tube, the screw nut being mounted around the ball-shaped connecting portion and screwed on the outer periphery of the receiving tube such that the annular clamping element is pivotally connected to the clamp-type positioning element, the annular clamping element having an upper section formed as an enclosing tube, the enclosing tube extending vertically and having an elliptical cross-section, the enclosing tube further having an upper end extended with a tube formed with a threaded hole in which the upper screw rod is screwed;
wherein a flashlight is fastened to the flashlight mount by inserting an end of the flashlight into the enclosing tube of the annular clamping element, rotating the upper screw rod downward to fix the flashlight in position, inserting an object to be clamped into the insertion space extending laterally into the lower section of the clamp-type positioning element, and rotating the lower screw rod upward to fasten the clamp-type positioning element to the object in a clamping manner, thus allowing the flashlight to be flexibly installed and angularly adjusted to a desired lighting direction.

2. The flashlight mount of claim 1, wherein the enclosing tube in the upper section of the annular clamping element is laterally provided with an outwardly extending space, the outwardly extending space enabling the enclosing tube to press resiliently against the flashlight fastened to the flashlight mount regardless of a cross-sectional shape of the flashlight, the outwardly extending space also being able to receive an engaging section which is provided on a lateral side of the flashlight and inserted in the outwardly extending space.

3. A flashlight mount, comprising an insertion-type positioning element, an annular clamping element, a screw nut, and an upper screw rod, the insertion-type positioning element having a lower section extended with an insertion part, the insertion part having a surface formed with at least a resilient pressing portion, the insertion-type positioning element having an upper section formed as a receiving tube, the receiving tube having an inwardly extending ball-shaped space and an outer periphery provided with threads, the receiving tube being circumferentially provided with a plurality of slots for allowing a ball-shaped connecting portion extending from a lower section of the annular clamping element to be inserted into the receiving tube, the screw nut being mounted around the ball-shaped connecting portion and screwed on the outer periphery of the receiving tube such that the annular clamping element is pivotally connected to the insertion-type positioning element, the annular clamping element having an upper section formed as an enclosing tube, the enclosing tube extending vertically and having an elliptical cross-section, the enclosing tube further having an upper end extended with a tube formed with a threaded hole in which the upper screw rod is screwed;
wherein a flashlight is fastened to the flashlight mount by inserting the flashlight into the enclosing tube of the annular clamping element, rotating the upper screw rod downward to fix the flashlight in position, and inserting the inserting part extending downward from the insertion-type positioning element into a predetermined space of an object to which the flashlight mount is to be connected, such that the at least a resilient pressing portion formed on the surface of the insertion part presses tightly against a wall of the predetermined space to fasten the insertion-type positioning element to the object, thus allowing the flashlight to be flexibly installed and angularly adjusted to a desired lighting direction.

4. The flashlight mount of claim 3, wherein the enclosing tube in the upper section of the annular clamping element is laterally provided with an outwardly extending space, the outwardly extending space enabling the enclosing tube to press resiliently against the flashlight fastened to the flashlight mount regardless of a cross-sectional shape of the flashlight, the outwardly extending space also being able to receive an engaging section which is provided on a lateral side of the flashlight and inserted in the outwardly extending space.

5. The flashlight mount of claim 3, wherein the insertion part of the insertion-type positioning element has a lower end laterally extended with a hook, the hook being engaged with a bottom portion of the object after the insertion part is inserted into the predetermined space of the object, so as to fix the flashlight mount in position to the object.
